(19) United States
(12) Patent Application Publication
(10) Pub. No.: US 2014/0115961 A1
(43) Pub. Date: May 1, 2014

(54) PASSIVE WATER SUPPLY SYSTEM FOR PLANT POT

(71) Applicant: CHIN-TAI TSAI, Taichung City (TW)

(72) Inventor: CHIN-TAI TSAI, Taichung City (TW)

(21) Appl. No.: 14/146,619

(22) Filed: Jan. 2, 2014

Related U.S. Application Data
(62) Division of application No. 13/244,515, filed on Sep. 25, 2011.

(30) Foreign Application Priority Data
Jan. 25, 2011 (TW) 100120263
Jul. 12, 2011 (TW) 100124524

(51) Int. Cl. A01G 9/02; A01G 27/02

(52) U.S. Cl. CPC A01G 9/02; A01G 27/02
USPC 47/79

(57) ABSTRACT

A pot assembly includes a pot having an inner part and an outer part connected to outside of the inner part. A hollow area is defined between the inner and outer parts. A recessed space is defined between the inner bottom and the periphery of the inner part. At least one hole is defined through the inner bottom of the inner part and communicates with the hollow area. A hollow hose is connected to the inner or outer part and communicates between outside of the hollow area and the hollow area. Air of outside of the hollow area communicates with the hollow area. A water-supply unit is located at the inner part and has its lower end communicating with the hollow area. A seal unit seals the top end of the water-supply unit. Liquid in the hollow area slowly spreads upward into the soil in the recessed space.

### FIELD OF THE INVENTION

The present application is a divisional application of applicant's prior patent application with the application Ser. No. 13/244,515, filed on Sep. 25, 2011.

### BACKGROUND OF THE INVENTION

The conventional pot for plants generally is made by ceramic or plastic which is made integrally by way of mold injection and includes a single layer, and a recessed area is defined in the center thereof and a hole is defined through the bottom of the pot. The soil is filled in the recessed area and the exceed water in the soil can escape from the hole in the bottom of the pot so that the soil is maintained in suitable water for providing good conditions for the plants in the pot.

However, during the growing process of the plant in the pot, the owner has to water proper amount of water to the plant. Most of the owners believe that more water supplied to the plants is better than less water so that usually the exceeded water and the soil flow from the hole of the pot. The soil and water make the floor messy and the soil flows from the pot quickly.

Furthermore, urban people live in high rise buildings so that the watering to the plants may cause water drop to the lower floors and this generally generates noise and the neighbors lived in the low floors may feel upset by the leaking water and soil.

The conventional pot has only one layer so that the heat from the sunshine is directly transferred to the plant of the pot so that the temperature and humidity at the bottom of the pot is too high so that the roots of the plants easily die.

When the owners travel away from homes, the plants can easily die because of lack of water.

The present invention intends to provide a hollow pot with a water supply system to improve the shortcomings mentioned above.

### SUMMARY OF THE INVENTION

The present invention relates to a pot assembly and comprises a pot having an inner part, an outer part, a seal unit, a water-supply unit and a hollow hose. The inner part has a recessed space defined therein and communicating with the open top of the inner part. The outer part is connected to the outside of the inner part. A hollow area is defined between the inner and outer parts. The recessed space is defined between the inner bottom and the periphery of the inner part. At least one hole is defined through the inner bottom of the inner part and communicates with the hollow area. The hollow hose has a top end communicating with outside of the hollow area, and a lower end of the hollow hose communicates with the hollow area. Air of the outside of the hollow area is in communication with the interior of the hollow area. The water-supply unit is connected to the inner part and has a lower end communicating with the hollow area. The seal unit seals the top end of the water-supply unit by a sealing member which is located between the seal unit and the top end of the water-supply unit.

Preferably, the inner part has a recess defined in the inner bottom thereof and the recess extends downward. The at least one hole is defined through the lower end of the recess of the inner bottom. A water-guide member is located in the recess and surrounded by the inside of the recess. The water-guide member is located on water paths between soil in the recessed space and the at least one hole. The top end of the water-guide member in the recess is higher than the lower end of the hollow hose.

Preferably, one end of the water-guide member extends through the at least one hole and reaches to the hollow area between the inner and outer parts. The water-guide member comprises multiple copper particles which are made by way of sintering. Irregular paths are defined between the particles.

Preferably, the hollow hose is integrally formed with the inner part or the outer part.

Preferably, the water-supply unit is connected to the outer part.

Preferably, the hollow hose is an individual member and connected to the inner part or the outer part.

The present invention supplies water to the soil so as to adjust the humidity of the soil within a long term of time such that the roots of the plants are not rotten. The hollow area of the pot assembly is used as a water storage area and the water can be spread and guided into the soil in a small amount to keep the soil wet so that the owners do not need to water the plants frequently. This allows the owners of the plants to travel away from home for a period of time without worry of watering of the plants.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view of the pot assembly of the present invention, and

FIG. 2 is a perspective view, partially removed, of the pot assembly of the present invention, and

FIG. 3 is a cross sectional view to show that a water bottle is connected to the water-supply unit of the pot assembly of the present invention.

### DETAILED DESCRIPTION OF THE PREFERRED EMBODIMENT

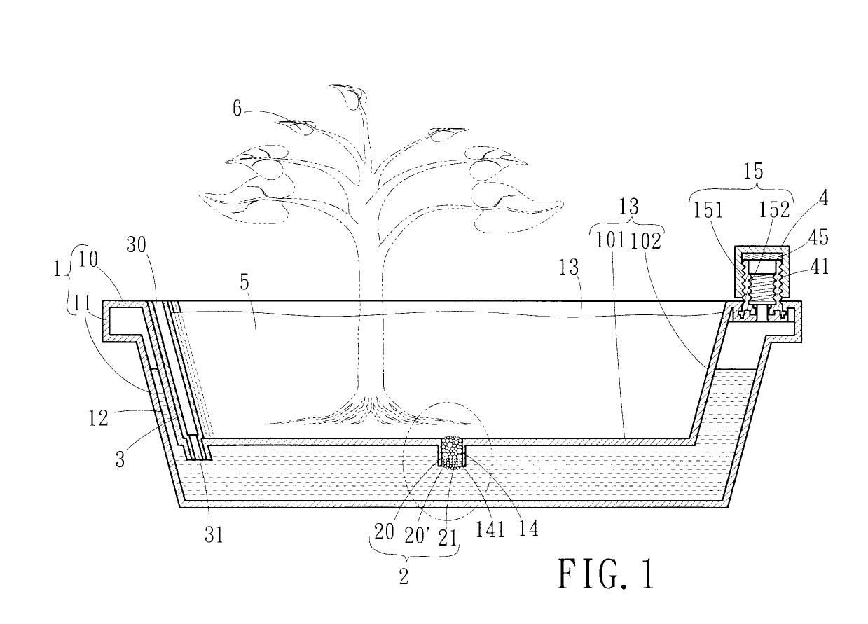

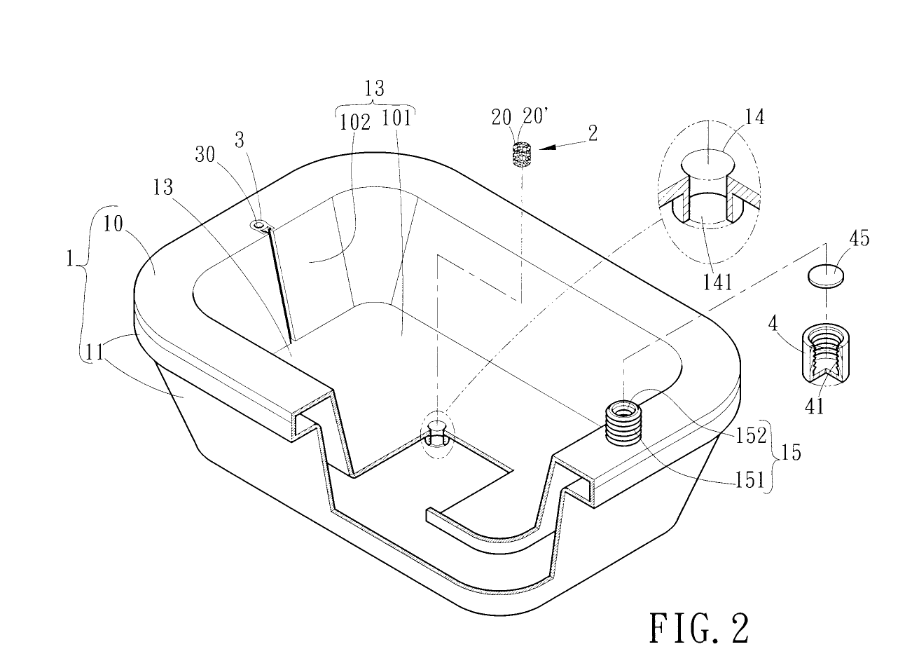

Referring to FIGS. 1 and 2, the pot assembly of the present invention comprises a pot 1 having an inner part 10, an outer part 11, a seal unit 4, a water-supply unit 15 and a hollow hose 3. The inner part 10 has a recessed space 13 defined therein and communicates with the open top of the inner part 10. The recessed space 13 is defined between the inner bottom 101 and the periphery 102 of the inner part 10. The outer part 11 is connected to the outside of the inner part 10. A hollow area 12 is defined between the inner and outer parts 10, 11. At least one hole 141 is defined through the inner bottom 101 of the inner part 10 and communicates with the hollow area 12.

The inner part 10 has a recess 14 defined in the inner bottom 101 thereof and the recess 14 extends downward. The at least one hole 141 is defined through the lower end of the recess 14 of the inner bottom 101. A water-guide member 2 is located in the recess 14 and surrounded by the inside of the recess 14. The water-guide member 2 is located on water paths between soil 5 in the recessed space 12 and the at least one hole 141. One end of the water-guide member 2 extends through the at least one hole 141 and reaches to the hollow area 12 between the inner and outer parts 10, 11. The water-guide member 2 comprises multiple copper particles 20, 20′ which are made by way of sintering and irregular paths 21 are defined between the particles 20, 20′.

The lowest position of the recess 14 or the hole 141 is located beneath the inner bottom 102, or slightly protrudes beyond the lowest position of the inner bottom 102 about 10 mm, so that the recess 14 or the hole 141 is hidden.

The hollow hose 3 is integrally formed with the inner part 10 or the outer part 11. Of course, the hollow hose 3 can be an individual member and is connected to the inner part 10 or the outer part 11. The hollow hose 3 has the top end 30 communicating with outside of the hollow area 12, and the lower end 31 of the hollow hose 3 communicates with the hollow area 12. The air of the outside of the hollow area 12 is in communication with the interior of the hollow area 12. The top end of the water-guide member 2 in the recess 14 is higher than the lower end 31 of the hollow hose 3.

The water-supply unit 15 is connected to the inner part 10 or the outer part 11, and has a lower end communicating with the hollow area 12 between the inner and outer parts 10, 11. The seal unit 4 seals the top end of the water-supply unit 15 by a sealing member 45 which is located between the seal unit 4 and the top end of the water-supply unit 15.

The water-supply unit 15 is a hollow unit and has one end extends through the inner pat 10 or the outer part 11, and communicates with the hollow area 12. The water-supply unit 15 has a locking portion 151 which has outer threads, and inner threads 152 defined in the inside thereof so that the seal unit 4 (including cover or cap) can be threadedly connected to the outer threads of the locking portion 151 of the water-supply unit 15. The sealing member 45 (such as a washer or gasket) is located between the seal unit 4 and the water-supply unit 15. Therefore, the hollow area 12 is sealed by the seal unit 4, such as the cover in FIG. 2 and the sealing member 45. The inner part 10 and the outer part 11 of the pot 1 are integrally connected to each other by way of blow molding, or by way of blow-mounting-molding, or the two parts 10, 11 are individually made and then connected to each other.

The particles 20, 20′ of the water-guide member 2 are made by way of sintering. The particles 20, 20′ are not rotten in the water such as metal particles (such as iron particles, silver particles, Tin particles, and copper particles). Stone particles, ceramic particles are also available. The copper particles 20, 20′ are preferable. Liquid in the hollow area 12 slowly spreads upward into the soil 5 in the recessed space 13 by way of the surface tension and the paths 21.

The seal unit 4 is an individual unit and has inner threads 41 (or hooks) defined in the inside thereof and the sealing member 45 is located at the bottom of the seal unit 4. The seal unit 4 is connected to the water-supply unit 15 by the inner threads 41 and the sealing member 45 is firmly clamped between the end surface of the water-supply unit 15 and the seal unit 4.

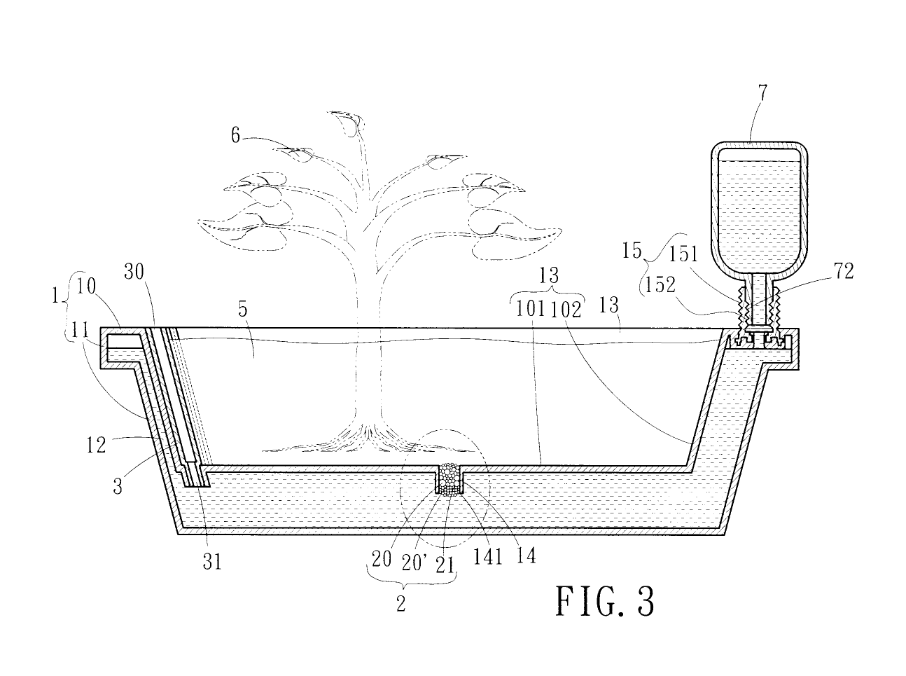

As shown in FIG. 3, a water bottle 7 with the outer threaded portion 72 can be connected to the water-supply unit 15 by threadedly connecting the outer threaded portion 72 of the water bottle 7 with the inner threads 152 of the water-supply unit 15. Therefore, the water bottle 7 is used as a water supply source to provide water into the hollow area 12.

Before planting the plant 6, the metal water-guide member 2 is installed in the hole 141 in the recess 14 and the other end of the water-guide member 2 extend through the hole 141 and reaches into the hollow area 12, so that the water-guide member 2 is located at water traces between the recessed space 13 and the at least one hole 141. Because the water-guide member 2 comprises multiple metal (copper) particles 20, 20′ which are made by way of sintering and have irregular paths 21 defined between the particles 20, 20′, so that the hollow area 12 and the recessed space 13 are in communication with each other. Soil 5 is poured into the space 13 and the plant 6 is planted into the soil 8. Watering the soil 5 and the water spreads the soil 5 and is eventually collected in the hallow area 12 so that the exceed water in the soil 5 flows into the hollow area 12 via the paths 21 between the particles 20, 20′. The exceed water is stored in the hollow area 12 to adjust the humidity of the soil 5 and does not leak.

Water can also be poured into the hollow area 12 via the water-supply unit 15 until the surface of the water in the hollow area 12 reaches the bottom of the recess 14. The water enters into the soil 5 by way of surface tension via the at least one hole 141 and the paths 21 of the water-guide member 2. The water slowly spreads the soil 5 via the at least one hole and the paths 21 and fills the area between the inside of the recess 14 and the water-guide member 2. The soil 5 located close to the surface of the water-guide member 2 is slightly wet. When water is continuously supplied from the water-supply unit 15, the surface of the water in the hollow area 12 raises until the surface reaches the maximum position. The inner threads 41 of the seal unit 4 is threadedly connected to the locking portion 151 to let the seal unit 4 properly connected to the water-supply unit 15.

Because the seal unit 4 and the water-supply unit 15 cannot be completely sealed, small amount of air enters from the gaps between the seal unit 4 and the water-supply unit 15. Therefore, the small amount of air applies a pressure to the water surface in the hollow area 12 so as to force the water molecular slowly flows into the soil 5 via the gaps between the at least one hole 141 and the water-guide member 2, until the soil 5 cannot absorb more water. In other words, the water molecular can be automatically supplied to the soil 5 via the gaps between the at least one hole 141 and the water-guide member 2, and this keeps the plant 6 alive even if the owners travel way from home for a period of time.

Furthermore, irregular paths 21 are defined between the particles 20, 20′ of the water-guide member 2 and the multiple metal particles (copper particles) are made by way of sintering. These particles are not rotten in the water and the paths 21 are not stocked by the soil 5 so that the paths 21 are ensured to be functioned properly to keep the humidity of the soil 5 in the recessed space 13 and filter the water passing through the paths 21.

While we have shown and described the embodiment in accordance with the present invention, it should be clear to those skilled in the art that further embodiments may be made without departing from the scope of the present invention.

What is claimed is:

1. A pot assembly comprising:
a pot having an inner part, an outer part, a seal unit, a water-supply unit and a hollow hose, the inner part having a recessed space defined therein and communicating with an open top of the inner part, the outer part connected to outside of the inner part, a hollow area defined between the inner and outer parts, the recessed space defined between an inner bottom and a periphery of the inner part, at least one hole defined through the inner bottom of the inner part and communicating with the hollow area;
the hollow hose having a top end communicating with outside of the hollow area, a lower end of the hollow hose communicating with the hollow area, air of outside of the hollow area being in communication with an interior of the hollow area;
the water-supply unit connected to the inner part and having a lower end communicating with the hollow area between the inner and outer parts, and the seal unit sealing a top end of the water-supply unit by a sealing member which is located between the seal unit and the top end of the water-supply unit.

2. The pot assembly as claimed in claim 1, wherein the inner part has a recess defined in the inner bottom thereof and the recess extends downward, the at least one hole is defined through a lower end of the recess of the inner bottom, a water-guide member is located in the recess and surrounded by an inside of the recess, the water-guide member is located on water paths between soil in the recessed space and the at least one hole, a top end of the water-guide member in the recess is higher than the lower end of the hollow hose.

3. The pot assembly as claimed in claim 2, wherein an end of the water-guide member extends through the at least one hole and reaches to the hollow area between the inner and outer parts, the water-guide member comprises multiple copper particles which are made by way of sintering, irregular paths are defined between the particles.

4. The pot assembly as claimed in claim 3, wherein the hollow hose is integrally formed with the inner part or the outer part.

5. The pot assembly as claimed in claim 4, wherein the water-supply unit is connected to the outer part.

6. The pot assembly as claimed in claim 3, wherein the hollow hose is an individual member and connected to the inner part or the outer part.

7. The pot assembly as claimed in claim 6, wherein the water-supply unit is connected to the outer part.
